(19) United States
(12) Patent Application Publication
(10) Pub. No.: US 2026/0133758 A1
(43) Pub. Date: May 14, 2026

(54) METHOD AND APPARATUS WITH IN-MEMORY OPERATION PERFORMING SCALE CASCADING

(71) Applicants: Samsung Electronics Co., Ltd., Suwon-si (KR); POSTECH RESEARCH AND BUSINESS DEVELOPMENT FOUNDATION, Pohang-si (KR)

(72) Inventors: Won-Jo LEE, Suwon-si (KR); Eunhyeok PARK, Pohang-si (KR); Byeori KIM, Pohang-si (KR); Changhun LEE, Pohang-si (KR); Jungyu JIN, Pohang-si (KR)

(73) Assignees: Samsung Electronics Co., Ltd., Suwon-si (KR); POSTECH RESEARCH AND BUSINESS DEVELOPMENT FOUNDATION, Pohang-si (KR)

(21) Appl. No.: 19/269,802

(22) Filed: Jul. 15, 2025

(30) Foreign Application Priority Data
Nov. 8, 2024 (KR) 10-2024-0158076

(51) Int. Cl. G06F 7/483

(52) U.S. Cl. CPC G06F 7/483

(57) ABSTRACT

The disclosure relates to a method and an apparatus with in-memory operation performing scale cascading. The apparatus for in-memory operation may assign quantization variables to respective groups of quantized data, transform the quantized data group by group through the quantization variables and a scale cascading method, obtain intermediate operation results by performing operations for each group, and accumulate operation results for each transformed group by applying a scale corresponding to the intermediate operation results for each group to obtain a final operation result.

### CROSS-REFERENCE TO RELATED APPLICATIONS

This application claims the benefit under 35 USC § 119 (a) of Korean Patent Application No. 10-2024-0158076, filed on Nov. 8, 2024, in the Korean Intellectual Property Office, the entire disclosure of which is incorporated herein by reference for all purposes.

### BACKGROUND

### 1. Field

The following description relates to a method and an apparatus with in-memory operation performing scale cascading.

### 2. Description of Related Art

Processing-in-Memory (PIM) has recently attracted attention as a next-generation architecture due to the explosive growth of large language models (LLMs) and the increasing demand for on-device AI, which PIM technology can help satisfy. Decoder-based transformers are currently the mainstream model, and the generative nature of an autoregressive scheme may involve the frequent use of general matrix-vector multiplication (GEMV) operations. Dynamic random-access memory (DRAM) PIM accelerators may provide an optimal hardware solution for on-device LLMs by locating operation units near memory cells to utilize the wide internal bandwidth of DRAM chips, thereby alleviating communication bottlenecks and reducing power consumption.

Various model optimization methods have been proposed to reduce the cost of LLMs, including weight-only quantization, which reduces a model's size through low-precision representation of the model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of performing an in-memory operation via scale cascading includes assigning quantization variables to respective groups of quantized data, transforming the quantized data group by group through the quantization variables and a scale cascading method, obtaining intermediate operation results by performing operations for each transformed group, and accumulating operation results for each group by applying a scale corresponding to the intermediate operation results for each group to obtain a final operation result.

The scale cascading method may be a method of dynamically adjusting a scale of a group that is an operation target, based on a scale corresponding to the group that is the operation target and based on a scale corresponding to a group that is a next operation target.

The obtaining of the intermediate operation results may include performing an accumulate operation within the group that is the operation target without considering the scale of the group that is the operation target.

The transforming of the quantized data by group may include performing scaled dequantization, which divides the scale of the quantized data by group through an arbitrary scale.

The transforming of the quantized data by group may be performed such that a zero offset included in the quantization variable of a corresponding group independently performs an accumulate operation.

The method may further include obtaining quantized data by converting integer data into floating point data based on a converter.

The converter may convert the integer data into the floating point data by assigning different scales and different zero offsets to the groups, respectively.

The converter may convert the integer data into the floating point data through fixed dequantization logic.

The fixed dequantization logic may convert the integer data into the floating point data using a fixed table in the conversion process, based on a predetermined quantized integer value and a predetermined scale value.

In another general aspect, an apparatus for in-memory operation performing scale cascading may assign quantization variables to respective groups of quantized data by group, transform the quantized data group by group through the quantization variables and a scale cascading method, obtain intermediate operation results by performing operations for each transformed group, and accumulate operation results for each group by applying a scale corresponding to the intermediate operation results for each group to obtain a final operation result.

The scale cascading method may dynamically adjust a scale of a group that is an operation target, based on a scale corresponding to the group that is the operation target and based on a scale corresponding to a group that is a next operation target.

The apparatus may perform an accumulate operation within the group that is the operation target without considering the scale of the group that is the operation target.

The apparatus may perform scaled dequantization, which divides the scale of the quantized data by group through an arbitrary scale.

The apparatus may transform the quantized data by group such that a zero offset included in the quantization variable of the corresponding group independently performs an accumulate operation.

The apparatus may further include a converter configured to obtain quantized data by converting integer data into floating point data.

The converter may convert the integer data into the floating point data by assigning different scales and different zero offsets to the groups, respectively.

The converter may convert the integer data into the floating point data through fixed dequantization logic.

The fixed dequantization logic may convert the integer data into the floating point data using a fixed table in the conversion process, based on a predetermined quantized integer value and a predetermined scale value.

In another general aspect, a memory device may include a memory controller configured to control an operation within memory, a bank configured to store data, a converter configured to obtain quantized data by converting integer data into floating point data, and an apparatus configured to perform an in-memory operation, wherein the apparatus may assign quantization variables to respective groups of quantized data, transform the quantized data group by group through the quantization variables and a scale cascading method, obtain intermediate operation results by performing operations for each transformed group, and accumulate operation results for each group by applying a scale corresponding to the intermediate operation results for each group to obtain a final operation result.

Other features and aspects will be apparent from the following detailed description, the drawings, and the claims.

### BRIEF DESCRIPTION OF THE DRAWINGS

FIG. 1 illustrates an example of a method of an in-memory operation through scale cascading, according to one or more embodiments.

FIG. 2 illustrates an example of an operation of an apparatus for in-memory operation, according to one or more embodiments.

FIG. 3 illustrates an example data flow of a memory device including an apparatus for in-memory operation, according to one or more embodiments.

FIG. 4 illustrates an example of a load scale operation, according to one or more embodiments.

FIG. 5 illustrates an example of a multiply scale, according to one or more embodiments.

FIG. 6 illustrates an example of an INT2FP converter, according to one or more embodiments.

FIG. 7 illustrates an example of a timing diagram of an apparatus for in-memory operation, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

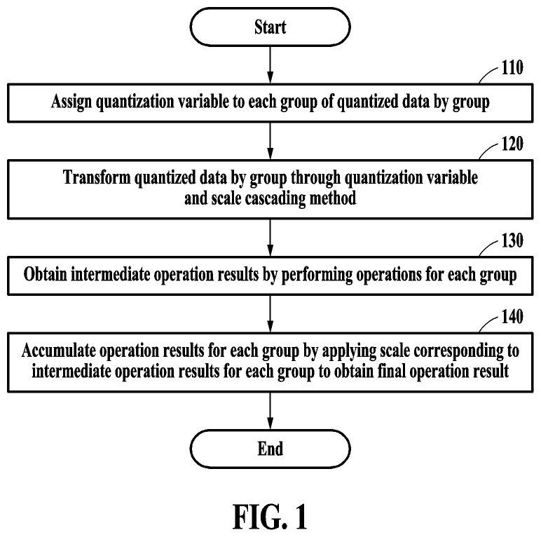

FIG. 1 illustrates an example of a method of an in-memory operation through scale cascading, according to one or more embodiments.

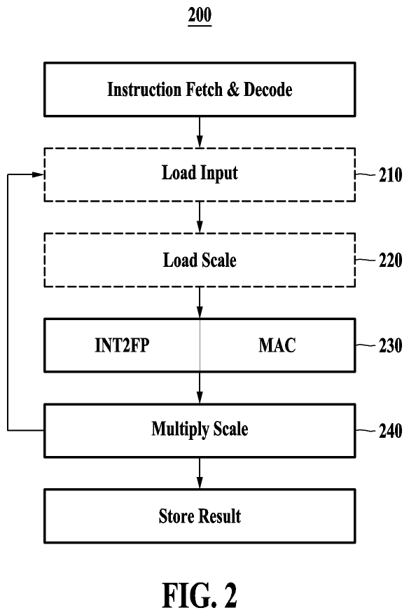

For ease of description, operations 110 to 140 are described as performed by an apparatus 200 for in-memory operation (see FIG. 2). However, operations 110 to 140 may be performed by another suitable electronic device in a suitable system.

In operation 110, the apparatus 200 for in-memory operation may assign quantization variables respective groups of quantized data.

The examples described below are based on representative scale-shift quantization. With respect to a floating point data x, linear quantization may map the floating point data x to a restrained quantized representation x of equal intervals through Equation 1 below.

$$\overline{x} = Q ( \frac{x - z}{s} , N , P ) * s + z , \qquad Equation 1$$

Here, N denotes the smallest quantized integer, P denotes the largest quantized integer, and the Q( ) function denotes a quantization function that performs clipping and rounding, based on which the floating point data may be mapped to an integer domain. z and s are quantization variables corresponding to a zero offset and a quantization step, respectively. N and P denote variables to be determined when a bit-width is given, and the s and z variables may generally be tuned to reduce quantization error. The described examples may be applied to nonlinear quantization as well as linear quantization, however, for ease of description, an example is provided in which linear quantization is applied, and only to the weights (quantization of other parameters would be similarly performed).

In the case of existing linear quantization, quantization may involve applying different quantization variables to an entire tensor or to each row thereof. When an input is x∈R^{I} and a weight is w∈R^{O×I} (I being the input dimension of the tensor, and indicates the number of elements of x), an output y∈R^{O} for a linear layer in which quantization is applied only to the weight may be determined as shown in Equation 2 below.

$${y}_{j} = {\sum }_{i} ( Q ( \frac{{W}_{j , i} - z}{s} , N , P ) * s + z ) \cdot {x}_{i} \qquad Equation 2$$

A group quantization algorithm may utilize different quantization variables for each group for given data. Since s and z may be tuned for smaller units of data, lower quantization errors may be expected. When the group quantization is applied to each g input row of weight (total number of groups: I/g), a corresponding output may be determined as shown in Equation 3 below.

$${y}_{j} = {\sum }_{k ∈ [ 0 , \frac{I}{g} ]} {\sum }_{i ∈ [ 0 , g )} ( Q ( \frac{{W}_{j , k * g + i} - {z}_{k}}{{s}_{k}} , N , P ) * {s}_{k} + {z}_{k} ) \cdot {x}_{k * g + i} \qquad Equation 3$$

After quantization, the quantized data (in integer form) and s and z may be stored in memory, and when operations are performed with the quantized data, the quantized integer data may be converted to high-precision data through dequantization and inference may be performed using a high-precision operator.

In operation 120, the apparatus 200 for in-memory operation may transform the quantized data by group through a quantization variable and a scale cascading method.

The scale cascading method may dynamically adjust a scale of a group that is an operation target, and may do so based on (i) a scale corresponding to the group that is the operation target and (ii) a scale corresponding to a group that is a next operation target.

The scale cascading method may be a scale chain-based operational simplification algorithm that may be used to sequentially accumulate result values and multiply the accumulated result values by scales to compute a final output.

In an example, the apparatus 200 for in-memory operation may perform scaled dequantization, which divides the scale of the quantized data by group through an arbitrary scale.

In an example, the apparatus 200 for in-memory operation may transform the quantized data by group such that a zero offset included in the quantization variable independently performs an accumulate operation.

In operation 130, the apparatus 200 for in-memory operation may obtain intermediate operation results by performing operations for each group.

In an example, the apparatus 200 for in-memory operation may perform an accumulate operation within the group that is the operation target, and may do so without considering the scale of the group that is the operation target.

In operation 140, the apparatus 200 for in-memory operation may accumulate operation results for each group by applying a scale corresponding to the intermediate operation results for each group to obtain a final operation result.

The above-described operations 120 to 140 may be performed by the apparatus 200 for in-memory operation configured to calculate the following equations.

In scale cascading, the existing group quantization formula, Equation 3, may be transformed into Equation 4.

$${y}_{j} = {\sum }_{k ∈ [ 0 , \frac{I}{g} ]} {s}_{k} \cdot ( {\sum }_{i ∈ [ 0 , g )} ( Q ( \frac{{W}_{j , k * g + i} - {z}_{k}}{{s}_{k}} , N , P ) + \frac{{z}_{k}}{{s}_{k}} ) \cdot {x}_{k * g + i} ) \qquad Equation 4$$

In Equation 4,

$$( {\sum }_{i ∈ [ 0 , g )} ( Q ( \frac{{W}_{j , k * g + i} - {z}_{k}}{{s}_{k}} , N , P ) + \frac{{z}_{k}}{{s}_{k}} ) \cdot {x}_{k * g + i} ) = {( wx )}_{k}$$

may be simplified and expressed as Equation 5.

$${y}_{j} = {\sum }_{k ∈ [ 0 , \frac{I}{g} ]} {s}_{k} \cdot {( wx )}_{k} \qquad Equation 5$$

Based on a transformation such as Equation 5, the apparatus 200 for in-memory operation may transform data by considering only the zero offset without multiplication for the scale based on data mapped to the integer domain. The apparatus 200 for in-memory operation may calculate a final result value by multiplying the scale for each group after accumulating the data.

For sequentially multiplied operations for each group, the above-described equations may be transformed into Equation 6 below.

$${y}_{j} = {s}_{\frac{I}{g} - 1} ( ( … ( \frac{{s}_{3}}{{s}_{2}} \cdot ( \frac{{s}_{1}}{{s}_{2}} \cdot ( \frac{{s}_{0}}{{s}_{1}} \cdot {( wo )}_{0} + {( wx )}_{1} ) + {( wx )}_{2} ) + {( wx )}_{3} ) + ⋯ ) + {( wx )}_{{s}_{\frac{I}{g} - 1}} ) \qquad Equation 6$$

According to Equation 6, from an internal buffer perspective, after calculations are simultaneously accumulated in groups (e.g., (wx)ₖ), by multiplying the scale for a corresponding group and dividing the scale of a group corresponding to the next operation, the scale of each value accumulated in the buffer may be transformed to fit the next group, thereby enabling continuous accumulation and operation in the apparatus 200 for in-memory operation. This may allow an accumulator to perform operations by simple accumulation without considering the scale, and only multiplying by the scale appropriate for the next group when moving to a new group may allow a quantization variable to be different for each group, which reduces quantization-related errors, thereby realizing the advantage of quantization at a low cost.

As described above, the scale cascading method may offset the scale of a group at the end of each operation for each group.

In an example, overflow/underflow may occur when a bit-width of an accumulator buffer is insufficient in the apparatus 200 for in-memory operation. As described above, applying linear quantization to the weights may result in the weights being mapped to an integer range. However, instead of an integer range, the range may be adjusted by applying an arbitrary scale and making the scale equally spaced. This approach may be expressed by Equation 7 below.

$$( {\sum }_{i ∈ [ 0 . g )} ( Q ( \frac{{W}_{j , k * g + i} - {z}_{k}}{{s}_{k}} , N , P ) + \frac{{z}_{k}}{{s}_{k}} ) \cdot {x}_{k * g + i} ) \cdot \frac{1}{} = {( wx )}_{k}^{′} \cdot \frac{1}{} \qquad Equation 7$$

[symbol] may have different values for each group, but it may be assumed that [symbol] has the same value for all groups (while the scale factor [symbol] may vary by group, it can be assumed to have the same value across all groups, that is, it may be assumed that the scale factor [symbol] varies by group but remains the same across all groups). In this case, an output according to scale cascading may be expressed by Equation 8 below.

$${y}_{j} = \frac{{s}_{\frac{I}{g} - 1}}{\tilde{s}} ( ( … ( \frac{{s}_{3}}{{s}_{2}} \cdot ( \frac{{s}_{1}}{{s}_{2}} \cdot ( \frac{{s}_{0}}{{s}_{1}} \cdot {( wx )}_{0}^{′} + {( wx )}_{1}^{′} ) + {( wx )}_{2}^{′} ) + {( wx )}_{3}^{′} ) + ⋯ ) + {( wx )}_{{s}_{\frac{I}{g} - 1}}^{′} ) \qquad Equation 8$$

In this example of transformation, the scale cascading method may also be applied, and changes may be added only when multiplying the last scale. The method of Equations 7 and 8 described above may be referred to as scaled dequantization.

Additionally, an independent zero-offset accumulation method may be applied in parallel. (wx)ₖ may be implemented by independently accumulating only the activations and adding considerations for the zero offset and scale. This may be expressed by Equation 9 below.

$${( wx )}_{k} = ( {\sum }_{i ∈ [ 0 , g )} ( Q ( \frac{{W}_{j , k * g + i} - {z}_{k}}{{s}_{k}} , N , P ) + \frac{{z}_{k}}{{s}_{k}} ) \cdot {x}_{k * g + i} ) = {\sum }_{i ∈ [ 0 , g )} Q ( \frac{{W}_{j , k * g + i} - {z}_{k}}{{s}_{k}} , N , P ) \cdot {x}_{k * g + i} + \frac{{z}_{k}}{{s}_{k}} {\sum }_{i ∈ [ 0 , g )} {x}_{k * g + i} \qquad Equation 9$$

Based on Equation 9, the apparatus 200 for in-memory operation may be simplified by inner product acceleration and high-precision accumulation & scale

$$( \frac{{z}_{k}}{{s}_{k}} )$$

transformation, based on low-high multi-precision.

Since the zero offset may be a factor that reduces dequantization error, the above-described method may reduce hardware cost and improve precision. In addition, the above-described method may be applied in parallel with a scale dequantization method (e.g., by storing

$$\frac{{z}_{k}}{{s}_{k}}$$

in a buffer).

The apparatus 200 for in-memory operation may include a converter 230. The converter 230 may convert the integer data into the floating point data by assigning different scales and different zero offsets to each group. In the described example, low-precision integer data may be efficiently converted into floating point data through fixed INT2FP dequantization logic of the converter 230. In this process, the conversion overhead may be reduced by using the scale cascading method.

The converter 230 may convert the integer data into the floating point data through fixed dequantization logic. Unlike the previous dynamic operation method, the converter 230 may fix/update the conversion table by using a predetermined scale value, so that the integer data may be quickly converted into the floating point data without requiring additional calculation for each operation.

The fixed dequantization logic may convert the integer data into the floating point data using a fixed table in the conversion process, based on a predetermined quantized integer value and a predetermined scale value. The fixed dequantization logic may include a table storing scaling information of predetermined integer data inside the converter 230, and may operate in a manner of outputting a floating point value of each corresponding integer value during the conversion process. The fixed dequantization logic may help reduce quantization errors and operation costs.

FIG. 2 illustrates an example of an operation of an apparatus for in-memory operation, according to one or more embodiments.

The description provided with reference to FIG. 1 is generally applicable to FIG. 2.

Referring to FIG. 2, the apparatus 200 for in-memory operation may receive an instruction from a memory controller (Instruction Fetch & Decode) and perform an operation process with multiple steps.

First, in a load input operation 210, the apparatus 200 for in-memory operation may retrieve input data from memory. The input data may be integer data and may be prepared for operation in the next step.

In a load scale operation 220, the apparatus 200 for in-memory operation may load scale values allocated to the groups, respectively. Each scale value may be used as a variable to convert quantized data to floating point data. The apparatus 200 for in-memory operation may utilize values determined by scale cascading or group quantization.

After that, the integer data may be converted into floating point data in the INT2FP converter 230. The INT2FP converter 230 may convert the integer data into floating point data based on a predetermined scale value using fixed dequantization logic. Additionally, the INT2FP converter 230 may improve the efficiency of operation by using a conversion table.

In multiply-accumulate (MAC), the converted floating point data may be used for accumulate operations. This process may be used to compute a final value by repeating fixed operations.

In a multiply scale operation 240, the apparatus 200 for in-memory operation may readjust the converted data by multiplying the scale values of each group. The apparatus 200 for in-memory operation may multiply the scale at the end of the operation and output a final result.

Finally, in a store result operation, a final operation result may be stored in memory.

Some steps in FIG. 2 may be omitted, depending on the situation.

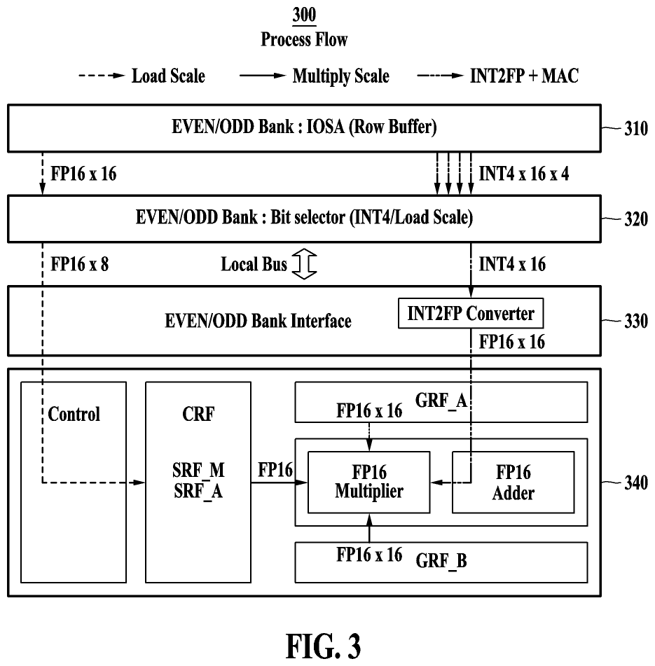

FIG. 3 illustrates an example of data flow of a memory device including an apparatus for in-memory operation, according to one or more embodiments.

The description provided with reference to FIGS. 1 and 2 is generally applicable to FIG. 3, and any repeated description related thereto may be omitted.

Referring to FIG. 3, a memory device 300 may include the apparatus 200 for in-memory operation, which may include various components to efficiently process data.

An input/output sense amplifier (IOSA) 310 may be a type of row buffer of an EVEN/ODD Bank, which may load and store data from memory. The IOSA 310 may improve the efficiency of data access in memory.

A bit selector 320 may select INT4 data and scale values to combine scale and integer data loaded by group. The bit selector 320 may perform a preparatory step for performing floating point operations by scaling integer data, and may utilize a scale cascading technique.

The INT2FP converter 330 may be a component configured to convert integer data into floating point data. The INT2FP converter 330 may convert the integer data quickly and efficiently using fixed dequantization logic and may support high-precision operations within memory.

An operator 340 may include various components to process the floating point data. The operator 340 may include an FP16 multiplier and an FP16 adder, and may perform high-precision operations to generate a final result. The operated data may be stored back into memory or used for further operations.

The above-described operations and components may interact with each other and transmit data through a local bus.

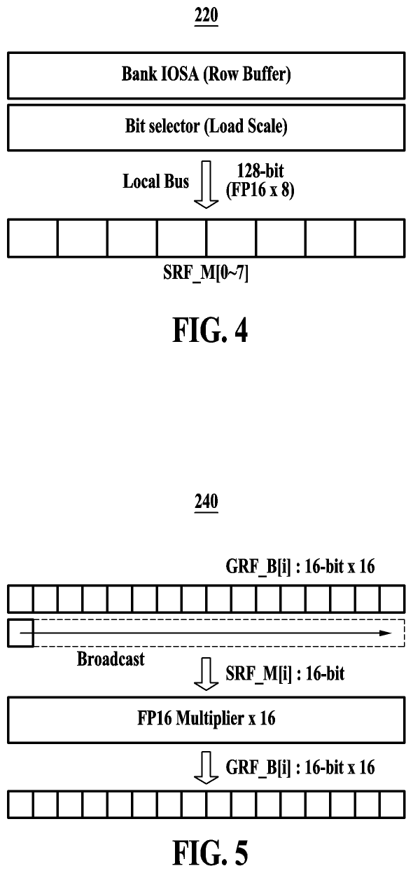

FIG. 4 illustrates an example of a load scale operation, according to one or more embodiments.

The description provided with reference to FIGS. 1 to 3 is generally applicable to FIG. 4, and any repeated description related thereto may be omitted.

Referring to FIG. 4, the load scale operation 220 may include loading and processing a scale value required in a process of converting integer data into floating point data. The bit selector 320 may select scale values loaded for each group and process the selected scale values along with the integer data. The bit selector 320 may prepare for conversion of quantized data into floating point data by applying an appropriate scale to each group. The scale may vary across the groups, and scale cascading may be performed.

A local bus may may transmit 128-bit data (FP16×8), and transfer data to a register file called SRF_M. The local bus may be configured to transfer loaded data and loaded scale values to an operation device. SRF_M[0˜7] is a register file that may store data and prepare for the next operation, and the data loaded for each bit may be used for the next operation.

The bank IOSA (row buffer) 310 may function as a row buffer that stores and accesses data in memory. The bank IOSA (row buffer) 310 may assist in smoothly handling data flow between memory and the operation device. The data may be read or written through the bank IOSA (row buffer) 310 and may be prepared for the next stage of operation.

FIG. 5 illustrates an example of a multiply scale, according to one or more embodiments.

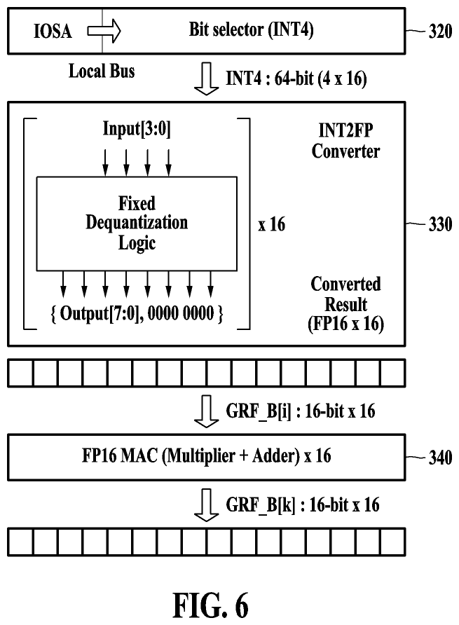

The description provided with reference to FIGS. 1 to 5 is generally applicable to FIG. 6.

The multiply scale 240 may include converting integer data into floating point data and then applying a scale value to perform a final operation.

GRF_B[i] is a register file including 16-bit×16 registers, and may store the floating point data. Specifically, GRF_B[i] may store and manage data required for the multiply scale, and may prepare data to be used in subsequent operations.

SRF_M[i] is a register that may transmit the data in which a scale value is applied in a broadcast manner. SRF_M[i] may be used for a preparatory step to multiply the scale values of each group by the corresponding floating point data, which may support fast data transmission. The multiply scale 240 may be performed via an FP16 multiplier (e.g., FP16 Multiplier×16). The FP16 multiplier may be an operator that multiplies 16 floating point data simultaneously, and multiplies the floating point data by a scale value applied to each group.

Finally, the operated result may be stored back into the GRF_B[i] register file. The stored result may be transferred back to memory or used in subsequent operations, allowing accurate data processing with scale applied.

FIG. 6 illustrates an example of an INT2FP converter, according to one or more embodiments.

The description provided with reference to FIGS. 1 to 5 is generally applicable to FIG. 6.

Referring to FIG. 6, the bit selector 320 may select INT4 data and process a scale value together therewith to convert the INT4 data into floating point data. The bit selector 320 may select data provided by the IOSA and transmit the data to the INT2FP converter 330 through the local bus.

The INT2FP converter 330 may convert integer data into floating point data using fixed dequantization logic. The fixed dequantization logic may simplify the process of converting integer data and may reduce computational overhead by using a predetermined conversion table. The INT2FP converter 330 may receive the INT4 data as input and convert the INT4 data into FP16 data, and the converted data may be used for subsequent high-precision operations.

More specifically, the INT2FP converter 330 may convert the integer data (e.g., INT4 data) into the floating point data (e.g., FP16 data). An internal operation of the INT2FP converter 330 may include the following process.

First, the integer data (e.g., INT4 data) may be input as Input [3:0]. The integer data (e.g., INT4 data) may be prepared to be converted to fit different scale values.

The fixed dequantization logic may convert the INT4 data to the FP16 data based on a predetermined conversion table. The fixed dequantization logic may be used to convert the integer data into floating point values based on a predetermined scale value. During the conversion process, instead of performing operations in real time, a fixed table may be used to locate FP16 values corresponding to each INT4 data.

The INT2FP converter 330 may be designed to have a structure in which 16 integer data may be processed in parallel, such that 16 INT4 data may be converted into 16 FP16 data at one time. The data converted in this process may be output as Output[7:0], and the converted data may be transferred to FP16 Multiply-Accumulate (FP16 MAC) for subsequent operations.

The converted FP16 data may be transferred to the operator 340 to perform operations such as multiplication and addition. FP16 MAC may process multiple floating point data simultaneously, and through this process, a final operation result may be generated. The operated result may be stored in a GRF_B[k] register file and may be used for subsequent operations or memory storage.

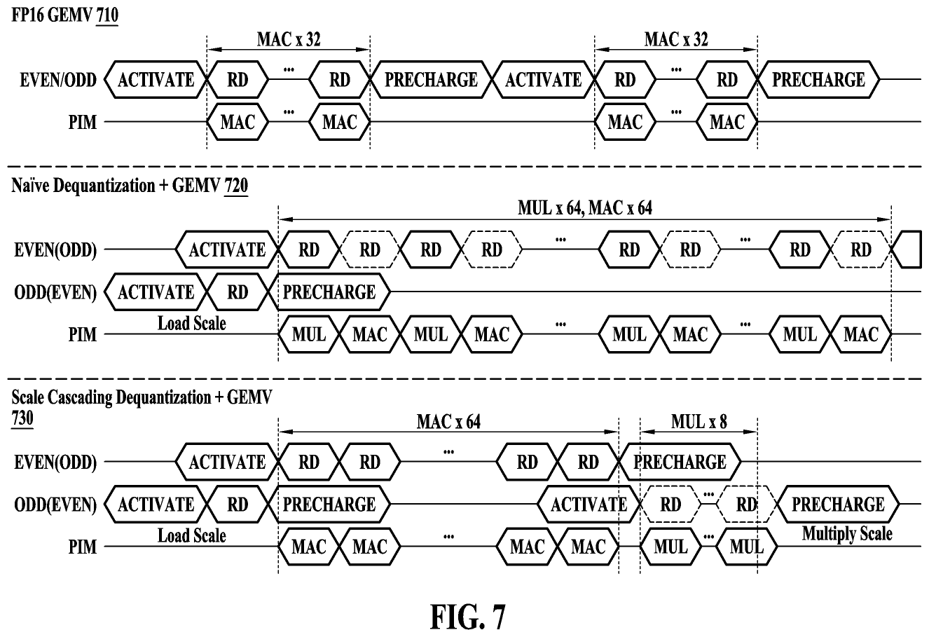

FIG. 7 illustrates an example of a timing diagram of an apparatus for in-memory operation, according to one or more embodiments.

The description provided with reference to FIGS. 1 to 6 is generally applicable to FIG. 7.

Referring to FIG. 7, the differences between FP16 GEMV 710, naïve dequantization+GEMV 720, and scale cascading dequantization+GEMV 730 may be seen in a timing diagram.

The FP16 GEMV 710 is an existing scheme that uses only floating point operations, where data activated in the EVEN/ODD Bank may be processed by iteratively performing read (RD) and multiply-accumulate operations (MAC).

The naïve dequantization+GEMV 720 is a scheme that includes simple dequantization, where a process of loading scale values at the ODD (EVEN) bank (load scale) may be added. In this scheme, integer data may be converted into floating point data, after which multiplication (MUL) operations and MAC operations may be performed. The naïve dequantization+GEMV 720 typically incurs additional computational burden during the scaling process.

The scale cascading dequantization+GEMV 730 performed by the apparatus 200 for in-memory operation may perform optimized operations by applying scale cascading. The load scale and multiply scale operations may be efficiently processed by loading and multiplying scale values at the EVEN/ODD bank, and then performing the MAC operations. This scheme may minimize computational overhead and provide higher performance through the scale cascading technique.

More specifically, the differences in how scale is applied in the scale cascading dequantization+GEMV 730 scheme and the naïve dequantization+GEMV 720 scheme may be seen in FIG. 7.

The naïve dequantization+GEMV 720 scheme may apply a scale value to each operation, such that the scale is multiplied again every time a MUL operation is performed, which may result in computational overhead. The scale cascading dequantization+GEMV 730 scheme may increase computational efficiency by applying the scale only once at the end, rather than applying the scale multiple times in intermediate stages.

In the naïve dequantization+GEMV 720 scheme, the integer data is converted into the floating point data, then the scale is multiplied, and then the MUL and MAC operations are performed. However, the process of loading and applying the scale value each time incurs additional memory access and computational overhead. In addition, loading and applying the scale value every time, and then repeating the MUL and MAC operations has a negative impact on the computation speed.

The scale cascading dequantization+GEMV 730 scheme may minimize the scale application while processing data in each group by using scale cascading. This scheme may reduce the overall computational cost by omitting intermediate scale multiplication when processing data for each group and instead applying the scale only once in the final stage. This scheme may optimize memory bandwidth and reduce the overhead of repeatedly applying scales.

For example, the scale cascading dequantization+GEMV 730 scheme may process more operations in parallel by using MUL x 8 and MAC x 64 structures. Using such structures may increase concurrent processing capabilities and improve computational speed. Since the scale application is not repeated in the intermediate steps, the overall operation flow may be simplified and may provide higher efficiency.

To reiterate, the scale cascading dequantization+GEMV 730 scheme may provide better performance and efficiency than the naïve dequantization+GEMV 720 scheme by eliminating unnecessary scale application in the intermediate operation process and applying the scale only once at the end.

The examples described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or combinations thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The computing apparatuses, the electronic devices, the processors, the memories, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of performing an in-memory operation via scale cascading, the method comprising:
assigning quantization variables to respective groups of quantized data;
transforming the quantized data group by group through the quantization variables and a scale cascading method;
obtaining intermediate operation results by performing an operation for each transformed group; and
accumulating operation results for each group by applying a scale corresponding to the intermediate operation results for each group to obtain a final operation result.

2. The method of claim 1, wherein the scale cascading method is a method of dynamically adjusting a scale of a group that is an operation target, based on a scale corresponding to the group that is the operation target and based on a scale corresponding to a group that is a next operation target.

3. The method of claim 1, wherein the obtaining of the intermediate operation results comprises performing an accumulate operation within the group that is the operation target without considering the scale of the group that is the operation target.

4. The method of claim 1, wherein the transforming of the quantized data by group comprises performing scaled dequantization, which divides the scale of the quantized data by group through an arbitrary scale.

5. The method of claim 1, wherein the transforming of the quantized data by group is performed such that a zero offset included in the quantization variable of a corresponding group independently performs an accumulate operation.

6. The method of claim 1, further comprising:
obtaining quantized data by converting integer data into floating point data based on a converter.

7. The method of claim 6, wherein the converter is configured to convert the integer data into the floating point data by assigning different scales and different zero offsets to the groups, respectively.

8. The method of claim 6, wherein the converter is configured to convert the integer data into the floating point data through fixed dequantization logic.

9. The method of claim 8, wherein the fixed dequantization logic is logic configured to convert the integer data into the floating point data using a fixed table in a conversion process, based on a predetermined quantized integer value and a predetermined scale value.

10. A non-transitory computer-readable storage medium storing instructions that, when executed by a processor, cause the processor to perform the method of claim 1.

11. An apparatus for in-memory operation performing scale cascading, wherein the apparatus is configured to,
assign quantization variables to respective groups of quantized data,
transform the quantized data group by group through the quantization variables and a scale cascading method,
obtain intermediate operation results by performing an operation for each transformed group, and
accumulate operation results for each group by applying a scale corresponding to the intermediate operation results for each group to obtain a final operation result.

12. The apparatus of claim 11, wherein the scale cascading method comprises dynamically adjusting a scale of a group that is an operation target, based on a scale corresponding to the group that is the operation target and based on a scale corresponding to a group that is a next operation target.

13. The apparatus of claim 11, wherein the apparatus is configured to perform an accumulate operation within the group that is the operation target without considering the scale of the group that is the operation target.

14. The apparatus of claim 11, wherein the apparatus is configured to perform scaled dequantization, which divides the scale of the quantized data by group through an arbitrary scale.

15. The apparatus of claim 11, wherein the apparatus is configured to transform the quantized data by group such that a zero offset included in the quantization variable of the corresponding group independently performs an accumulate operation.

16. The apparatus of claim 11, further comprising:
a converter configured to obtain quantized data by converting integer data into floating point data.

17. The apparatus of claim 16, wherein the converter is configured to convert the integer data into the floating point data by assigning different scales and different zero offsets to the groups, respectively.

18. The apparatus of claim 16, wherein the converter is configured to convert the integer data into the floating point data through fixed dequantization logic.

19. The apparatus of claim 18, wherein the fixed dequantization logic is logic configured to convert the integer data into the floating point data using a fixed table in a conversion process, based on a predetermined quantized integer value and a predetermined scale value.

20. A memory device, comprising:
a memory controller configured to control an operation within memory;
a bank configured to store data;
a converter configured to obtain quantized data by converting integer data into floating point data; and
an apparatus configured to perform an in-memory operation,
wherein, the apparatus is further configured to,
assign quantization variables to respective groups of quantized data,
transform the quantized data group by group through the quantization variables and a scale cascading method,
obtain intermediate operation results by performing an operation for each transformed group, and
accumulate operation results for each group by applying a scale corresponding to the intermediate operation results for each group to obtain a final operation result.
